(19) United States
(12) Patent Application Publication
(10) Pub. No.: US 2026/0326535 A1
(43) Pub. Date: Oct. 22, 2026

(54) DEVICE FOR THE ACOUSTIC TREATMENT OF A VENTILATION SYSTEM

(71) Applicant: VALEO SYSTEMES THERMIQUES, Le Mesnil-Saint-Denis (FR)

(72) Inventors: Charlie Bricault, Le Mesnil-Saint-Denis (FR); Mathieu Caparros, Le Mesnil-Saint-Denis (FR)

(73) Assignee: VALEO SYSTEMES THERMIQUES, Le Mesnil-Saint-Denis (FR)

(21) Appl. No.: 19/114,729

(22) PCT Filed: Sep. 13, 2023
(86) PCT No.: PCT/EP2023/075081

§ 371 Date: Mar. 24, 2025

(30) Foreign Application Priority Data
Sep. 22, 2022 (FR) 2209584

(51) Int. Cl. B60K 11/08; B60K 11/04; H01M 10/613; H01M 10/625; H01M 10/6561

(52) U.S. Cl. CPC B60K 11/08; B60K 11/04; H01M 10/613; H01M 10/625; H01M 10/6561

(57) ABSTRACT

An acoustic treatment device for a cooling system of a vehicle is disclosed herein. The acoustic treatment device is configured to be fitted to a cooling system of a vehicle and includes at least one wall which delimits a duct for the circulation of an air flow. The acoustic treatment device includes at least one array of resonators formed by one or more rows of resonators arranged around the duct perpendicular to an axis of elongation of the duct. Each resonator of a row of resonators includes at least one cavity arranged in the wall and a neck connecting the cavity to the duct. For a given dimension of the cavity or of the neck, at least one resonator of the row of resonators has a value that is different from the value of the corresponding dimension of the other resonators of the row.

The present invention falls within the field of vehicle ventilation systems, and more particularly within the field of devices for the acoustic treatment of such systems, where appropriate in a vehicle battery cooling system.

Vehicle battery cooling systems may be positioned in the front end of the vehicle. The front-end modules that they contribute to forming comprise means for drawing in air external to the vehicle and a heat exchanger though which the air thus drawn in is guided in order to cool a liquid that flows in the heat exchanger and is intended to cool the batteries within the battery pack of the vehicle. Air is made to flow through such cooling systems by the operation of a ventilation device and both this operation and the flow of air within the ducts of the system involve the emission of acoustic waves, which can cause considerable levels of undesirable noise.

This undesirable noise phenomenon is all the more present in recent electric vehicles, which have bulky battery packs and can be recharged by rapid charging processes. While the batteries are being rapidly charged, their temperature increases rapidly and the maximum temperature reached is high. In order to compensate for this heating, the ventilation device of the cooling system must operate at a very high rotational speed, this causing considerable levels of noise outside the vehicle when it is at a standstill. This noise can also be annoying for any passengers present in the vehicle interior while the batteries are being charged.

It is known to fit systems fitted with a ventilation device with at least one acoustic attenuation device in order to reduce the acoustic energy radiated at the outlet of said ventilation devices, as illustrated in document FR3083298. This type of acoustic attenuation device comprises, for example, an array of Helmholtz resonators. The dimension and shapes of this array of resonators are configured to dissipate the most acoustic energy possible in order to avoid the operation of the cooling system causing noise in the surrounding area and/or for the users of the vehicle.

This type of acoustic attenuation device conventionally relies on absorbing acoustic waves at the interfaces formed by the walls, in order to use a dissipation effect to attenuate the acoustic energy propagating through a duct of the ventilation installation that guides, for example, an air stream toward the vehicle interior.

However, the motor vehicle front-end modules, which comprise a blower opening and an intake opening, one on each side of one or more heat exchangers, that generate low-frequency waves between 200 and 1000 Hz, causing a major annoyance for pedestrians. These low frequencies of high wavelength are difficult for conventional acoustic attenuation devices to treat. This difficulty is all the greater when the volumes available are restricted, this being the case for intake or blower openings of the front-end modules, the restricted nature of the available volumes being defined by the relationship between the depth available for integrating an attenuation device and the wavelength associated with the frequency of the waves to be treated.

The present invention aims to improve the existing solutions by proposing an acoustic treatment device intended to be fitted to a vehicle cooling system, the acoustic treatment device comprising at least one wall contributing to delimiting a duct for the flow of an air stream, said duct being arranged, around an axis of elongation, parallel to the flow direction of an air stream through the duct, the acoustic treatment device comprising at least one array of resonators which is formed by one of more rows of resonators disposed around the duct, each resonator of a row of resonators comprising at least a cavity disposed in the wall and a neck connecting said cavity to the duct, characterized in that, at least for one given dimension of the cavity or of the neck, at least one resonator of the row has a different value to the value for the corresponding dimension of the other resonators of the row.

The acoustic treatment device according to the invention makes it possible to treat multiple acoustic wave frequencies with a single row of resonators, and thus with a smaller space requirement. The acoustic treatment device thus makes it possible to treat acoustic waves over a given frequency bandwidth. This frequency bandwidth will depend on the limits imposed by physics, which depend on the available integration volumes. In order to treat a target frequency band, the proposed device is provided with a parallel array of Helmholtz resonators, in other words an array positioned on one same perpendicular row in the direction of propagation of the waves. Taking an optimization process as a basis, some of the resonators of the same row are dimensioned differently than the others in order to attenuate the waves over the target frequency band.

The treatment of acoustic waves of a first frequency, which is within the target frequency band, is the aim of the first resonators of the row, which have given dimensions, whereas the treatment of acoustic waves of another frequency, which is distinct from the first frequency and within the target frequency band, is the aim of other resonators of the same row which have different dimensions. The acoustic treatment device developed according to the invention thus makes it possible to decrease the perception of a greater frequency bandwidth both on the outside of the vehicle and by the driver and/or the passengers present in the vehicle interior.

The resonators may in particular be Helmholtz resonators. The resonators are, in the acoustic treatment device of the invention, arranged around the duct in one or more rows, it being possible for the feature of the invention according to which resonators of one same row have different dimensions from one resonator to the next to be applied to one or to each of the rows.

In this case, a “row” is understood to mean that the resonators are arranged one after another around a cross section of the duct as seen in a plane perpendicular to the axis of elongation of the duct, which defines the direction of propagation of the acoustic waves. In other words, the resonators of one same row are disposed such that one same plane, extending perpendicular to the axis of elongation of the duct, or axis of propagation of the acoustic waves, passes through them.

In addition, the term “given dimension” of the resonator is in particular a selected reference dimension of said resonator, the “corresponding dimension” corresponding to the given dimension of said resonator measured on another resonator of the same row. It will be understood, for example, that if the length of the cavity of a resonator is selected as the given dimension, the corresponding dimension on another resonator being the length of the cavity of said other resonator, the two lengths will be different to one another.

Furthermore, two dimensions are different within the meaning of the invention insofar as they go beyond a simple deviation from one resonator to another owing to a manufacturing tolerance. There is considered to be a difference in dimensions from one resonator to another within one same row, as established by one feature of the invention, if this difference has an effect on the acoustic treatment of waves over a frequency range of about 3 to 4 Hz.

According to an optional feature of the invention, the given dimension corresponds to a height of the cavity measured along a direction parallel to an axis of extent of the neck.

According to another optional feature of the invention, the given dimension corresponds to a width of the cavity measured along a direction perpendicular to an axis of elongation of the duct and to an axis of extent of the neck.

According to another optional feature of the invention, the given dimension corresponds to a length of the cavity measured along a direction parallel to the axis of elongation of the duct.

According to another optional feature of the invention, the given dimension corresponds to a height of the neck measured along a direction parallel to an axis of extent of the neck.

According to another optional feature of the invention, the dimension corresponds to a radius of the neck measured along a direction perpendicular to the axis of extent of the neck.

According to another optional feature of the invention, at least one resonator of the row of resonators has a given dimension identical to the corresponding dimension of its neighboring resonators. It will be understood that the resonators are not all different to one another within one same row.

According to another optional feature of the invention, the row of resonators comprises a first subgroup of resonators having a given dimension of a first value and at least one second subgroup of resonators having a second value, different to the first value, for the given dimension, the first subgroup of resonators being disposed on a first portion of the acoustic treatment device whereas the second subgroup of resonators is disposed on a second portion, distinct from the first portion, of the acoustic treatment device. It will be understood that the resonators of the row of resonators having one same given dimension are disposed one after another around the duct.

According to another optional feature of the invention, the row of resonators comprises a first subgroup of resonators having a given dimension of a first value and at least one second subgroup of resonators having a second value, different to the first value, for the given dimension, the resonators of the first subgroup of resonators alternating with the resonators of the second subgroup of resonators.

According to another optional feature of the invention, at least the neck of one of the resonators of the row of resonators is offset, along the axis of elongation, from the necks of the other resonators of the row of resonators.

Here, the notion of an axial offset of the necks of resonators of one same row should be understood as meaning that a position along the axis of elongation of one of the necks associated with a resonator of a determined row is different to the position of another neck associated with another resonator of this row, along the axis of elongation. This different position reflects a determined offset of the theoretical position of the necks, such that it should be understood that the axial offset between two necks of two resonators of one same row in accordance with the invention is greater than a minimum offset owing to manufacturing tolerances of each of the necks. The axial offset between two necks of two resonators of one same row makes it possible to optimize the acoustic treatment, by implementing an phenomenon of interference of a plane-wave field.

According to an optional feature of the invention, the row of resonators comprises at least one first subassembly of resonators through the necks of which a first plane perpendicular to the axis of elongation passes and a second subassembly through the necks of which a second plane perpendicular to the axis of elongation passes, the first plane and the second plane being distinct from one another. It should be understood that the cavities of the resonators of the row are centered relative to one another and that only the necks of some of the resonators, i.e. those forming the first subassembly mentioned. In other words, the system according to the invention indeed comprises one same row of resonators with off-center necks of a subassembly of resonators.

According to another optional feature of the invention, the resonators of the first subassembly are disposed one after another, the resonators of the second subassembly being disposed one after another.

According to another optional feature of the invention, the duct emerges from an air-stream inlet opening and from an air-stream outlet opening, the necks of the resonators of the first subassembly of resonators being disposed closer to the duct inlet opening than to the duct outlet opening, whereas the necks of the resonators of the second subassembly of resonators are disposed closer to the duct outlet opening than to the duct inlet opening.

According to another optional feature of the invention, the resonators of the first subassembly are disposed on a first wall face opposite a second wall face on which the resonators of the second subassembly are disposed.

According to another optional feature of the invention, the resonators of the first subassembly alternate with the resonators of the second subassembly.

The present invention also relates to a vehicle front-end module intended to interact with a vehicle heating, ventilating and air-conditioning system, the front-end module comprising at least one air-stream guide device contributing to delimiting a duct through which the air stream flows, a ventilator capable of making the air stream flow through the guide device, a heat exchanger across the guide device, and an acoustic treatment device characterized according to any one of the features above. It will be understood here that the acoustic treatment device forms all or some of the guide device, and that the duct of the acoustic treatment device and the duct of the guide device are continuous.

Other features, details and advantages of the invention will become more clearly apparent on reading the description below and on studying several exemplary embodiments given by way of non-limiting indication with reference to the appended schematic drawings, in which:

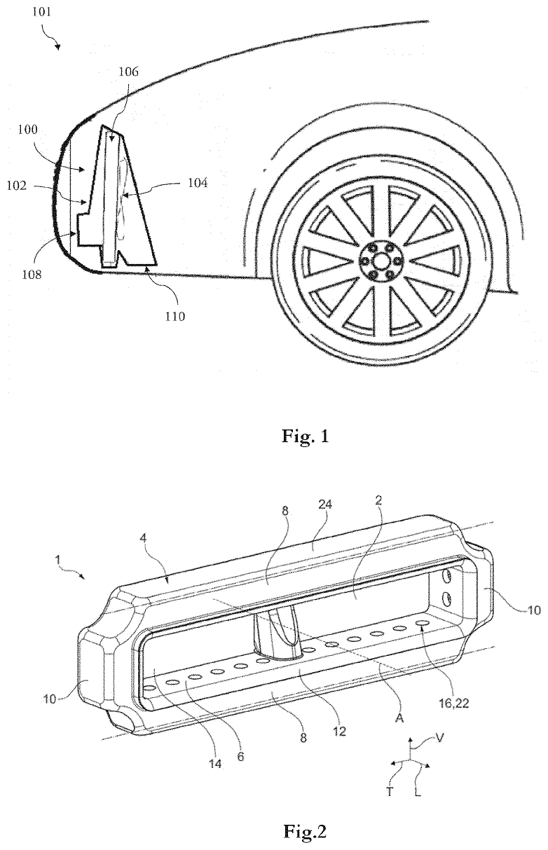

FIG. 1 is a schematic depiction of a front end of a motor vehicle fitted with a front-end module in which an acoustic treatment device according to the invention is mounted;

FIG. 2 is a perspective depiction of a first embodiment of the acoustic treatment device according to the invention;

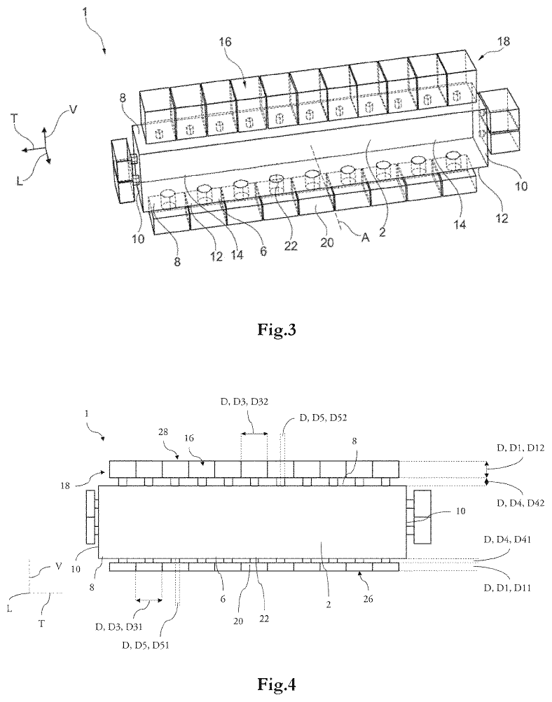

FIG. 3 is a perspective depiction of the resonators and of a duct of the acoustic treatment device illustrated in FIG. 2, one wall of the acoustic treatment device having been removed to make the resonators visible;

FIG. 4 is a cross section through the acoustic treatment device illustrated in FIG. 3;

FIG. 5 is a cross section through a variant of the acoustic treatment device;

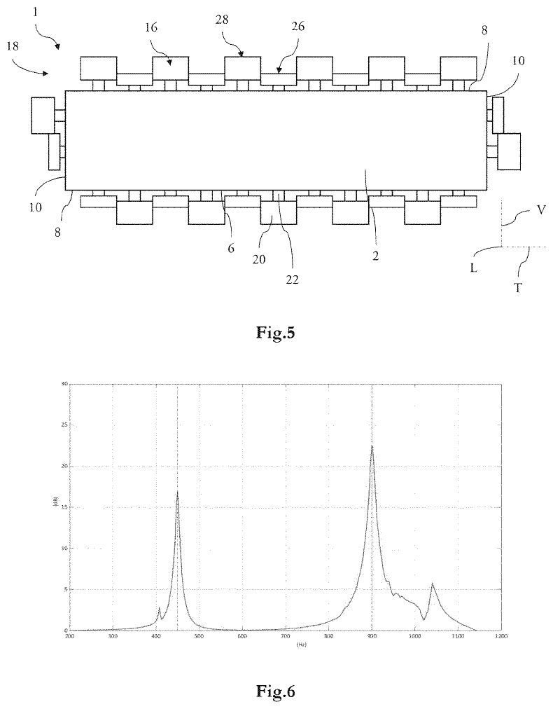

FIG. 6 is a diagram illustrating the reduction in acoustic energy realized by the acoustic treatment device in FIG. 3 for acoustic waves of a frequency of 490 Hz and for acoustic waves of a frequency of 900 Hz;

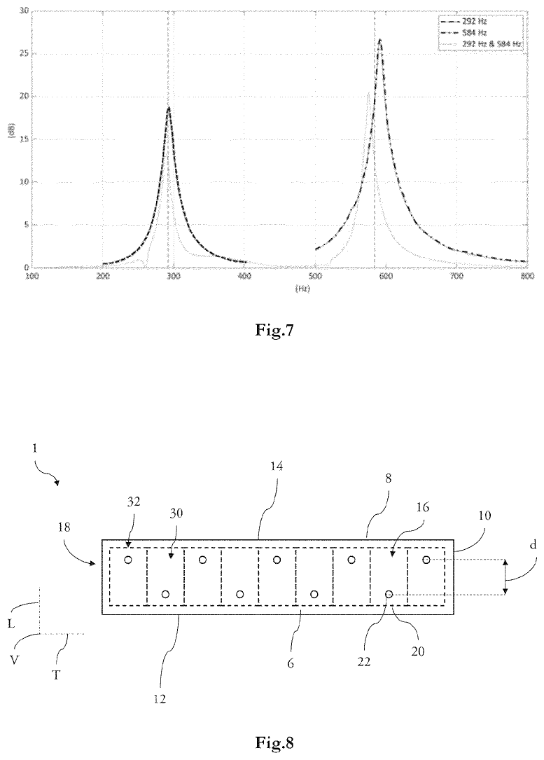

FIG. 7 is a diagram enabling a comparison between, on the one hand, the effectiveness of the acoustic treatment device of FIG. 3, which is capable of acoustically treating waves of a first frequency of 292 Hz and waves of a second frequency of 584 Hz, and on the other hand the effectiveness of two acoustic treatment devices of the prior art, each of which separately treats the waves of the first frequency and the waves of the second frequency;

FIG. 8 is a schematic depiction of a variant embodiment of the invention, and more particularly of one face of the wall delimiting the duct into which the resonators open, showing an axial offset of the resonators within one same row;

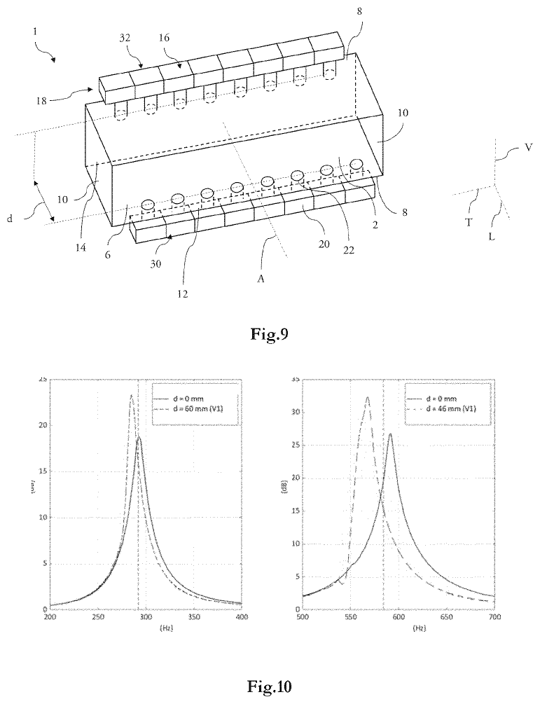

FIG. 9 is a longitudinal section through a variant of the acoustic treatment device illustrated in FIG. 8;

FIG. 10 is a diagram illustrating the reduction in acoustic energy realized by the acoustic treatment device in FIG. 8 for acoustic waves of a frequency of 292 Hz and for acoustic waves of a frequency of 584 Hz.

The features, variants and the various embodiments of the invention may be combined with one another, in various combinations, as long as they are not mutually incompatible or mutually exclusive. It will be possible, in particular, to conceive of variants of the invention that comprise only a selection of the features described below, in isolation from the other features described, if this selection of features is sufficient to confer a technical advantage and/or to distinguish the invention from the prior art.

In the figures, elements that are common to several figures retain the same reference signs.

In the following detailed description, the terms “longitudinal”, “transverse” and “vertical” refer to the orientation of an acoustic treatment device according to the invention. A longitudinal direction corresponds to a main flow direction of an air stream through the acoustic treatment device and an axis of elongation of a duct of the acoustic treatment device, this longitudinal direction being parallel to a longitudinal axis L of an orthonormal coordinate system L, V, T illustrated in the figures. A transverse direction and a vertical direction correspond to directions that are perpendicular to the longitudinal direction, respectively parallel to a transverse axis T and to a vertical axis V of the coordinate system L, V, T.

FIG. 1 illustrates an acoustic treatment device 1 according to the invention, which is configured to be installed within a front-end module 100 of a vehicle 101. Such a front-end module 100 comprises, for example, at least one air-stream guide device 102 contributing to delimiting a duct 2 through which the air stream flows, a ventilator 104 capable of making the air stream flow through the guide device, a heat exchanger 106 for the air stream flowing through the guide device, and the acoustic treatment device 1 according to the invention. More particularly, the ventilator makes an air stream flow through the device from the external environment of the vehicle via the guide device, and the heat exchanger is installed across the duct 2 and is configured to be able to cool a liquid also flowing within this exchanger for the purpose of cooling, in another zone of the vehicle, a battery pack.

The use of the ventilator generates acoustic waves at different frequencies, which propagate through the front-end module. The acoustic treatment device 1 is configured to attenuate the acoustic energy of the acoustic waves which can be perceived from outside the vehicle and/or by a user of the vehicle. The acoustic treatment device 1 may in particular be arranged at the inlet of the front-end module, specifically an intake opening 108, or at the outlet of the front-end module, specifically a blower opening 110.

Irrespective of the position of the acoustic treatment device 1 in relation to the guide device, the acoustic treatment device 1 contributes to delimiting the duct 2 through which the air stream is made to flow. More particularly, and as illustrated in FIG. 2, the acoustic treatment device 1 comprises at least one wall 4, and more particularly an inner face 6, which contributes to at least partially delimiting the duct 2 through which the air stream can flow.

The inner face 6 of the wall 4 is configured such that it delimits the duct 2 around an axis of elongation A extending parallel to the flow direction of the air stream through the duct 2.

The wall 4 more particularly comprises four sections, including two transverse sections 10 and two vertical sections 8 extending respectively in planes substantially perpendicular to the planes in which the transverse sections 10 lie, the inner face of the wall being defined by the successive inner faces of the different sections. The sections are arranged such that a cross section of the duct 2 delimited by the wall 4, as seen in a plane perpendicular to the axis of elongation A, has a rectangular overall shape delimited transversely by the inner faces 6 of the transverse sections 10 and vertically by the inner faces 6 of the vertical sections 8. It is also possible to define an inlet opening 12 of the duct 2 and an outlet opening 14 of said duct 2 defining the longitudinal dimension of the duct 2 through the acoustic treatment device 1. The terms “inlet” and “outlet” are selected in particular with respect to the flow direction of the air stream through the duct 2.

In order to treat the acoustic energy through the duct 2 of the acoustic treatment device 1, the latter comprises at least one array of resonators 16 which is formed by one or more rows 18 of resonators 16 disposed in the wall 4 around the duct 2. Each resonator 16 of a row 18 of resonators 16 comprises at least a cavity 20 disposed in the wall 4 and a neck 22 connecting said cavity 20 to the duct 2. The resonators 16 are advantageously Helmholtz resonators. As mentioned above, resonators are arranged in one same row 18 if they are arranged around one same cross section of the duct 2 as seen in a plane perpendicular to the axis of elongation A, i.e. if one same plane, in this case a transverse and vertical plane, passes through each of these resonators. The various figures of the present application illustrate an acoustic treatment device in an application with a smaller space requirement, in this case a front-end module, which involves the presence of a single row of resonators. However, the description below is also suitable for acoustic treatment devices which have multiple rows of resonators, if at least one of the rows exhibits the features that will be described.

As mentioned above and as illustrated in FIGS. 3 to 5, 8 and 9, each of the resonators comprises a cavity 20 and a neck 22 connecting the cavity 20 to the duct 2, the resonators being visible in these figures because the wall delimiting the duct 2 is concealed. More particularly, the wall 4 has a thickness measured along a direction perpendicular to the axis of elongation A between the inner face 6 of the wall 4 that faces the duct and an opposite outer face 24, and the cavities 20 are disposed in the thickness of the wall 4. The neck 22 of each of the resonators 16 also extends in the thickness of the wall 4, opening on one side into the cavity 20 and on the other side into the duct 2.

The cavities 20 have a parallelepipedal overall shape in the wall 4, having a substantially rectangular cross section as seen in a plane perpendicular to the axis of elongation A. The necks 22, for their part, have a cylindrical overall shape of circular cross section between the cavity 20 and the duct 2.

According to the invention, at least for a given dimension D of the cavity 20 or of the neck 22, one or more resonators 16 of the row 18 have a value for the dimension D that is different to the value of the corresponding dimension D of at least one other resonator 16 of the same row 18. The difference in values for the dimension D from one resonator to another within one same row 18 makes it possible to treat acoustic waves of two different frequencies, the acoustic waves of a first frequency being for example treated mainly by the resonators 16 of given dimensions, whereas the acoustic waves of a second frequency, distinct from the first frequency, are treated mainly by a resonator 16 of different dimensions. The acoustic treatment device 1 developed according to the invention thus makes it possible to decrease the perception of a greater wave frequency range by the driver and/or the passenger present in the vehicle interior.

In addition, at least one resonator 16 of the row 18 of resonators 16 has a given dimension D identical to the corresponding dimension D of its neighboring resonators 16. It will be understood that the resonators 16 are not all different to one another within one same row 18, at least for a given dimension D.

It is thus possible to define that the row 18 of resonators 16 comprises a first subgroup 26 of resonators 16 having a given dimension D of a first value and at least one second subgroup 28 of resonators 16 having a second value, which is different to the first value, for the given dimension D. More generally, according to the invention, the resonators 16 may be grouped into a defined number of subgroups for treating the acoustic energy for this defined number of distinct propagation frequencies.

As regards the dimensions D previously mentioned in the description, the term “given dimension D” of the resonator 16 is in particular a selected reference dimension D of said resonator 16, the “corresponding dimension D” corresponding to the given dimension D of said resonator 16 measured on another resonator 16 of the same row 18. It will be understood, for example, that if the length D2 of the cavity 20 of a resonator 16 is selected as the given dimension D, the corresponding dimension D on another resonator 16 being the length D2 of the cavity 20 of said other resonator 16, the two lengths D2 will be different to one another.

The given dimension D may be selected from the following non-exhaustive list: a height D1 of the cavity 20, a length D2 of the cavity 20, a width D3 of the cavity 20, a height D4 of the neck 22 and/or a radius D5 of the neck 22.

The height D1 of a cavity 20 corresponds to the greatest extent of the cavity 20 measured along a direction parallel to an axis of extent of the neck 22.

The length D2 of a cavity 20 corresponds to the greatest extent of the cavity 20 measured along a direction parallel to an axis of elongation A of the duct 2.

The width D3 of a cavity 20 corresponds to the greatest extent of the cavity 20 measured along a direction perpendicular to the axis of elongation A of the duct 2 and to an axis of extent of the neck 22.

The height D4 of a neck 22 corresponds to the greatest extent of the neck 22 measured along a direction parallel to an axis of extent of the neck 22 between a point at which the neck 22 opens into the cavity 20 and a point at which the neck 22 opens into the duct 2.

The radius D5 of a neck 22 corresponds to half of the greatest extent measured along a direction perpendicular to the axis of extent of the neck 22.

By way of example, an acoustic treatment device according to the invention may be configured such that the first subgroup 26 of resonators 16 can treat acoustic waves of a frequency ranging between 400 Hz and 500 Hz, for example 450 Hz, and the second subgroup 28 of resonators 16 can treat acoustic waves of a frequency ranging between 850 Hz and 950 Hz, for example 900 Hz.

In another test, the inventors were able to verify the effectiveness of a device in which a distinction can be made between a first subgroup 26 of resonators 16, dimensioned to treat acoustic waves of a frequency ranging between 250 Hz and 300 Hz, for example 292 Hz, and a second subgroup 28 of resonators 16, dimensioned to treat acoustic waves of a frequency ranging between 550 Hz and 600 Hz, for example 584 Hz.

A more detailed description will now be given of an exemplary embodiment in which the dimensions of the resonators 16 of the first subgroup 26 are configured to acoustically treat acoustic waves having a frequency of 450 Hz, and in which the dimensions of the resonators 16 of the second subgroup 28 are configured to acoustically treat acoustic waves having a frequency of 900 Hz.

In the rest of the description, the description of the features of one resonator 16 of the first subgroup 26 can be applied to all of the resonators 16 of the first subgroup 26.

Equivalently, the description of the features of one resonator 16 of the second subgroup 28 can be applied to all of the resonators 16 of the second subgroup 28.

In this case, the length D2 of the resonators 16 of the first subgroup 26 and of the resonators 16 of the second subgroup 28 is identical and equal to 80.0 mm.

In this particular example, the resonator 16 of the first subgroup 26 has a first height D11 of the cavity 20 ranging between 22.0 mm and 24.5 mm. More particularly, the first height D11 of the cavity 20 of the resonator 16 of the first subgroup 26 is 23.5 mm. In addition, the resonator 16 of the first subgroup 26 has a first width D31 of the cavity 20 ranging between 30.0 mm and 33.5 mm. More particularly, the first width D31 of the cavity 20 of the resonator 16 of the first subgroup 26 is 31.7 mm.

The resonator 16 of the first subgroup 26 also has a first height D41 of the neck 22 ranging between 1.9 mm and 2.1 mm. More particularly, the first height D41 of the neck 22 of the resonator 16 of the first subgroup 26 is 2.0 mm.

Lastly, the resonator 16 of the first subgroup 26 has a first radius R51 of the neck 22 ranging between 9.0 mm and 10 mm. More particularly, the first radius R51 of the neck 22 of the resonator 16 of the first subgroup 26 is 9.5 mm.

The dimensions of the resonator 16 of the second subgroup 28 are different in that it has a second width D12 of the cavity 20 ranging between 34.5 mm and 38.0 mm. More particularly, the second height D12 of the cavity 20 of the resonator 16 of the second subgroup 28 is 36.3 mm.

In addition, the resonator 16 of the second subgroup 28 has a second width D32 of the cavity 20 ranging between 47.5 mm and 52.5 mm. More particularly, the second width D32 of the cavity 20 of the resonator 16 of the second subgroup 28 is 50.0 mm.

The resonator 16 of the second subgroup 28 also has a second height D42 of the neck 22 ranging between 16.0 mm and 18.0 mm. More particularly, the second height D42 of the neck 22 of the resonator 16 of the second subgroup 28 is 17.0 mm.

Lastly, the resonator 16 of the second subgroup 28 has a second radius D52 of the neck 22 ranging between 9.5 mm and 10.5 mm. More particularly, the second radius D52 of the neck 22 of the resonator 16 of the second subgroup 28 is 10.0 mm.

As illustrated in FIG. 6, which reflects the amount of acoustic energy attenuated, as defined by the ratio between the amount of energy as input and the amount of energy as output, as a function of the frequencies of the acoustic waves within the duct fitted with the acoustic treatment device, the dimensions of the resonators 16 of the first subgroup 26 makes it possible to attenuate acoustic waves with a frequency of 450 Hz, in particular in this case by reducing the acoustic energy of these waves propagating in the duct by approximately 17 dB, whereas the dimensions of the resonators 16 of the second subgroup 28 makes it possible to attenuate acoustic waves with a frequency of 900 Hz, in particular in this case by reducing the acoustic energy of these waves propagating in the duct by approximately 22 dB.

The presence of resonators 16 of the first subgroup 26 and resonators 16 of the second subgroup 28 around the duct 2 makes it possible to treat both acoustic waves of a first frequency and acoustic waves of a second frequency. The inventors were able to note that such a combined acoustic treatment makes it possible to effectively treat acoustic waves of two different frequencies, without adversely affecting the effectiveness of the acoustic treatment for each specific frequency. By way of example, FIG. 7 uses a solid line to illustrate the amount of acoustic energy reduced with an acoustic treatment device according to the invention which is configured to treat acoustic waves having a first frequency of 292 Hz and acoustic waves of a second frequency of 584 Hz in combination. It is notable in this figure that a device specifically configured to treat acoustic waves of this first frequency makes it possible to more greatly reduce the sound level, as shown in dashed line, and that a device specifically configured to treat acoustic waves of this second frequency makes it possible to more greatly reduce the sound level, as shown in dash-dotted line, but the inventors have noted that the reduced maximum performance for each frequency is advantageously compensated for by the advantage in being able to effectively treat a wide range of frequencies using one same acoustic treatment device.

In the example illustrated in FIGS. 3 and 4, the resonators 16 of the row 18 of resonators 16 having one same given dimension D are disposed one after another around the duct 2. The first subgroup 26 of resonators 16 is thus disposed on a first portion of the acoustic treatment device 1 whereas the second subgroup 28 of resonators 16 is disposed on a second portion, distinct from the first portion, of the acoustic treatment device 1 More particularly, in this example, the first subgroup 26 is disposed both on one of the vertical sections 8 and one of the transverse sections 10, whereas the second subgroup 28 is disposed both on the other vertical section 8 and the other transverse section 10 of the wall 4.

According to an alternative example of the invention illustrated in FIG. 5, the resonators 16 of the first subgroup 26 of resonators 16 alternate with the resonators 16 of the second subgroup 28 of resonators 16. It will be understood that the resonators 16 of the first subgroup 26 and the resonators 16 of the second subgroup 28 are disposed on each of the vertical sections 8 and the transverse sections 10 of the wall 4 such that at least one resonator 16 of the first subgroup 26 is framed by two resonators 16 of the second subgroup 28, and that at least one resonator 16 of the second subgroup 28 is framed by two resonators 16 of the first subgroup 26.

A description will now be given of a different functionality that can be implemented in addition to what has just been described. The resonators 16 of one same row can also differ in terms of their axial positioning within the duct, in addition to differing by their dimensions.

As illustrated in FIGS. 8 and 9, at least the neck 22 of one of the resonators 16 of the row 18 of resonators 16 is axially offset, along the axis of elongation A, from the necks 22 of the other resonators 16 of the same row 18 by a distance d. The longitudinal axial offset of the neck 22 of at least one of the resonators 16 from the necks 22 of the other resonators 16 of the row 18 makes it possible to increase the reduction in the noise level while reducing the space requirement, by taking advantage of a phase interference phenomenon, assuming a plane-wave field.

In other words, a position along the axis of elongation A of one of the necks 22 is different to the position of another neck 22 along this axis of elongation A. To this end, at least one of the necks 22 of the row 18 of resonators 16 is closer to the inlet opening 12 than to the outlet opening 14 of the duct 2, and/or at least one of the other necks 22 of the row 18 of resonators 16 is closer to the outlet opening 14 than to the inlet opening 12 of the duct 2.

It is thus possible to define that the row 18 of resonators 16 comprises at least one first subassembly 30 of resonators 16 through the necks 22 of which a first plane perpendicular to the axis of elongation A passes and a second subassembly 32 through the necks 22 of which a second plane perpendicular to the axis of elongation A passes, the first plane and the second plane being distinct from one another. It will be understood that the necks 22 of the resonators 16 of the first subassembly 30 are aligned with one another by lying in the first plane, whereas the necks 22 of the resonators 16 of the second subassembly 32 are aligned with one another by lying in the second plane.

In the example illustrated and shown in FIGS. 8 and 9, the necks 22 of the resonators 16 of the first subassembly 30 are disposed closer to the inlet opening 12 of the duct 2 than to the outlet opening 14 of the duct 2, and the necks 22 of the resonators 16 of the second subassembly 32 are disposed closer to the outlet opening 14 of the duct 2 than to the inlet opening 12 of the duct 2.

A distance d measured along a direction parallel to the axis of elongation A between the neck 22 of one of the resonators 16 of the first subassembly 30 and the neck 22 of one of the resonators 16 of the second subassembly 32 ranges between 30 mm and 80 mm. This distance is in this case measured along a direction parallel to the axis of elongation A between straight lines which are perpendicular to this axis of elongation A and pass through the centers of the two necks 22. By way of example, such a distance measured between the neck 22 of one of the resonators 16 of the first subassembly 30 and the neck 22 of one of the resonators 16 of the second subassembly 32 may be about 46 mm or about 60 mm. This distance may depend on the dimensional characteristics of the resonators 16 of the row and/or on the frequency of the acoustic waves to be treated.

FIG. 10 schematically illustrates the acoustic gain made possible by a configuration in accordance with what has just been described, i.e. an axial offset of some of the necks of the resonators from other necks of the same row of resonators. The inventors were able to determine by calculation that, for resonators disposed in a front-end module and configured to treat acoustic waves having a frequency of 292 Hz, a distance d between the two subassemblies of resonators can advantageously equal 60 mm, and that for the resonators disposed in a front-end module and configured to treat acoustic waves having a frequency of 584 Hz, a distance d between the two subassemblies of resonators can advantageously equal 46 mm. FIG. 10 illustrates that, for each of these distances d and the corresponding frequency of the treated acoustic waves, the acoustic energy can be reduced by about 20 to 30%. It will be understood that, for other acoustic wave frequencies, the inventors would mathematically determine this distance d such that it is optimum and minimizes the acoustic energy transmitted in order to avoid it being perceived by a user of the vehicle and from the outside of the vehicle.

In a first configuration, illustrated in FIG. 8 and shown in FIG. 2, the resonators 16 of the first subassembly 30 alternate with the resonators 16 of the second subassembly 32. In other words, at least one resonator 16 of the first subassembly 30 is framed by two resonators 16 of the second subassembly 32 and at least one resonator 16 of the second subassembly 32 is framed by two resonators 16 of the first subassembly 30.

As an alternative, and as illustrated in FIG. 9, the resonators 16 of the first subassembly 30 may be disposed one after another, and the resonators 16 of the second subassembly 32 are disposed one after another. In the example illustrated, the resonators 16 of the first subassembly 30 are disposed one after another by being disposed on one of the vertical sections 8 whereas the resonators 16 of the second subassembly 32 are disposed one after another on the other vertical section 8, but it will be understood that the resonators 16 of the first subassembly 30 could also extend on one of the transverse sections 10 whereas the resonators 16 of the second subassembly 32 could then extend on the other transverse section 10.

In a variant not illustrated here, the acoustic treatment device 1 according to the invention can be configured such that the resonators 16 of one same row 18 are divided both into a first subgroup 26 and into a second subgroup 28 like those previously described in the description, and into a first subassembly 30 and into a second subassembly 32 as described above. It will be understood that one same resonator 16 is a member both of one of the subgroups and of one of the subassemblies. A resonator 16 can thus be a member of the first subgroup 26 and of the first subassembly 30 or of the second subassembly 32, or of the second subgroup 28 and of the first subassembly 30 or of the second subassembly 32.

The invention that has just been described by way of several embodiments makes it possible to achieve its stated objective, i.e. to optimize the reduction in acoustic energy that is transmitted and capable of being perceived by the user of a motor vehicle and from the outside of the vehicle, in an application of an acoustic treatment device with resonators disposed in an environment with a reduced space requirement. The different dimensions of the resonators within one same row of resonators advantageously makes it possible to increase the range of acoustic wave frequencies that can be effectively treated by the acoustic treatment device and makes it possible to implement the acoustic treatment device with a reduced number of rows of resonators.

The present invention is not, however, limited to the means and configurations described and illustrated herein and it also extends to any equivalent means and configuration and to any technically feasible combination of such means. In particular, the examples of the dimensions and distribution of the resonators 16 in the acoustic treatment device 1 are given by way of indication and do not limit the invention.

1. An acoustic treatment device configured to be fitted to a vehicle cooling system, the acoustic treatment device comprising:
at least one wall contributing to delimiting a duct for a flow of an air stream,
wherein said duct is arranged, around an axis of elongation, parallel to the a flow direction of an air stream through the duct; and
at least one array of resonators which is formed by one of more rows of resonators disposed around the duct,
wherein each resonator of a row of resonators comprising at least a cavity disposed in the wall and a neck connecting said cavity (20) to the duct,
wherein at least for one given dimension of the cavity or of the neck, at least one resonator of the row has a different value to the value for the corresponding dimension of the other resonators of the row.

2. The acoustic treatment device as claimed in claim 1, wherein the given dimension D5, corresponds to a height of the cavity measured along a direction parallel to an axis of extent of the neck.

3. The acoustic treatment device as claimed in claim 1, wherein the given dimension D4, corresponds to a width of the cavity measured along a direction perpendicular to the axis of elongation of the duct and to an axis of extent of the neck.

4. The acoustic treatment device as claimed in claim 1, wherein the given dimension corresponds to a height of the neck measured along a direction parallel to an axis of extent of the neck.

5. The acoustic treatment device as claimed in claim 1, wherein the given dimension corresponds to a radius of the neck measured along a direction perpendicular to the axis of extent of the neck.

6. The acoustic treatment device as claimed in claim 1,
wherein the row of resonators comprises a first subgroup of resonators having a given dimension of a first value and at least one second subgroup of resonators having a second value, different to the first value, for the given dimension,
wherein the first subgroup of resonators is disposed on a first portion of the acoustic treatment device whereas the second subgroup of resonators is disposed on a second portion, distinct from the first portion, of the acoustic treatment device.

7. The acoustic treatment device as claimed in claim 1,
wherein the row of resonators comprises a first subgroup of resonators having a given dimension of a first value and at least one second subgroup of resonators having a second value, different to the first value, for the given dimension,
wherein the resonators of the first subgroup of resonators alternating with the resonators of the second subgroup of resonators.

8. The acoustic treatment device as claimed in claim 1, wherein at least the neck of one of the resonators of the row of resonators is offset, along the axis of elongation, from the necks of the other resonators of the row of resonators.

9. A vehicle front-end module configured to interact with a vehicle cooling system, the vehicle front-end module comprising:
at least one air-stream guide device contributing to delimiting a duct through which the air stream flows;
a ventilator configured to make the air stream flow through the guide device;
a heat exchanger disposed across the guide device; and
the acoustic treatment device characterized as claimed in claim 1.
